(19) United States
(12) Patent Application Publication
(10) Pub. No.: US 2024/0195859 A1
(43) Pub. Date: Jun. 13, 2024

(54) ADDITION OF DEVICES IN A MOBILE CLUSTER

(71) Applicants: LinGe QIU, Pleasant Hill, CA (US); Jesus VALENZUELA, Seatle, WA (US); Edward BARTON, Dublin, CA (US); Cliff COLLINS, Dublin, CA (US)

(72) Inventors: LinGe QIU, Pleasant Hill, CA (US); Jesus VALENZUELA, Seatle, WA (US); Edward BARTON, Dublin, CA (US); Cliff COLLINS, Dublin, CA (US)

(73) Assignee: ADAPDIX CORPORATION, Pleasanton, CA (US)

(21) Appl. No.: 18/079,663

(22) Filed: Dec. 12, 2022

(51) Int. Cl. H04L 67/01

(52) U.S. Cl. CPC H04L 67/01

(57) ABSTRACT

A method for addressing anomalies in an Internet of things (IOT) device, the IOT device being a part of a mobile cluster is described. The method comprises determining whether the IOT device produces an anomaly based at least on a first machine learning model, determining adjustments for recommending in functioning of the IOT device based at least on a second machine learning model in response to a determination that the IOT device produces the anomaly, sending the recommended adjustments to one or more user devices that are a part of the mobile cluster for loading the recommended adjustments on to the mobile cluster, and receiving a selection of one or more of the recommended adjustments from the one or more user devices for facilitating addressal of the anomaly in the IOT device.

### FIELD OF THE INVENTION

The embodiments discussed in the present disclosure are generally related to anomalies in Internet of things (IOT) devices. In particular, the embodiments discussed are related to addressing anomalies in IOT devices by adding user devices to a mobile cluster.

### BACKGROUND OF THE INVENTION

With regards to anomalies and problems in functioning of devices, a traditional pager type support tends to “page” on the anomalies and problems reported by the devices, and escalate if no user and/or technician responds within a predetermined amount of time. In particular, a list of users in the pager's calendar who are authorized to address the anomalies and problems, is defined. The traditional pager type support may not be practical in an IOT monitoring environment because of the fact that an IOT network is a giant network of connected devices and people, all of which collect and share data about the way the connected devices are used and about the environment around the connected devices. Further, conventional methods of addressing anomalies and problems reported by IOT devices require a dashboard per IOT network, and assigning a technician per IOT network.

Accordingly, there is a need in the art to address anomalies and problems reported by IOT devices of the IOT monitoring environment such that addressing the anomalies and problems reported by the IOT devices is practical in nature and does not require a dashboard per IOT network.

### SUMMARY OF THE INVENTION

Embodiments of a method, a corresponding apparatus, and a corresponding system are disclosed that address at least some of the above-challenges and issues.

According to some embodiments of the disclosure, an apparatus for addressing anomalies in an Internet of things (IOT) device, the IOT device being a part of a mobile cluster is described. The apparatus comprises a memory and a processor coupled to the memory. The processor is configured to determine whether the IOT device produces an anomaly based at least on a first machine learning model, determine adjustments to recommend in functioning of the IOT device based at least on a second machine learning model in response to a determination that the IOT device produces the anomaly, send the recommended adjustments to one or more user devices that are a part of the mobile cluster to load the recommended adjustments on to the mobile cluster, and receive a selection of one or more of the recommended adjustments from the one or more user devices to facilitate addressal of the anomaly in the IOT device.

According to some embodiments of the disclosure, the recommended adjustments are sent to widgets of the one or more user devices in response to a determination that the one or more user devices are active in the mobile cluster.

According to some embodiments of the disclosure, the one or more user devices are determined to be active and part of the mobile cluster at least when the one or more user devices are positioned in a network zone and/or an indoor mapping location at the premises of the IOT device.

According to some embodiments of the disclosure, the processor is further configured to send notifications to one or more inactive user devices to wake up for possible user activity.

According to some embodiments of the disclosure, the one or more inactive user devices correspond to user devices other than the active user devices.

According to some embodiments of the disclosure, the one or more inactive user devices become active in response to the notifications to wake up for possible user activity.

According to some embodiments of the disclosure, the processor is further configured to identify a same anomaly and a way of addressing the same anomaly and send a notification regarding the way of addressing the same anomaly to the one or more user devices when the same anomaly is produced.

According to some embodiments of the disclosure, the mobile cluster is at least a Kubernetes cluster.

According to some embodiments of the disclosure, a method for addressing anomalies in an Internet of things (IOT) device, the IOT device being a part of a mobile cluster is described. The method comprises determining whether the IOT device produces an anomaly based at least on a first machine learning model, determining adjustments for recommending in functioning of the IOT device based at least on a second machine learning model in response to a determination that the IOT device produces the anomaly, sending the recommended adjustments to one or more user devices that are a part of the mobile cluster for loading the recommended adjustments on to the mobile cluster, and receiving a selection of one or more of the recommended adjustments from the one or more user devices for facilitating addressal of the anomaly in the IOT device.

According to some embodiments of the disclosure, the method further comprises sending the recommended adjustments to widgets of the one or more user devices in response to a determination that the one or more user devices are active in the mobile cluster.

According to some embodiments of the disclosure, the one or more user devices are determined to be active and part of the mobile cluster at least when the one or more user devices are positioned in a network zone and/or an indoor mapping location at the premises of the IOT device.

According to some embodiments of the disclosure, the method further comprises sending notifications to one or more inactive user devices to wake up for possible user activity.

According to some embodiments of the disclosure, the one or more inactive user devices correspond to user devices other than the active user devices.

According to some embodiments of the disclosure, the one or more inactive user devices become active in response to the notifications to wake up for possible user activity.

According to some embodiments of the disclosure, the method further comprises identifying a same anomaly and a way of addressing the same anomaly and sending a notification regarding the way of addressing the same anomaly to the one or more user devices when the same anomaly is produced.

According to some embodiments of the disclosure, the mobile cluster is at least a Kubernetes cluster.

According to some embodiments of the disclosure, a system for addressing anomalies in a mobile cluster is described. The system comprises one or more user devices that are a part of the mobile cluster and an Internet of things (IOT) device, the IOT device being a part of a mobile cluster. Further, the IOT is configured to determine whether the IOT device produces an anomaly based at least on a first machine learning model, determine adjustments to recommend in functioning of the IOT device based at least on a second machine learning model in response to a determination that the IOT device produces the anomaly, send the recommended adjustments to one or more user devices that are a part of the mobile cluster to load the recommended adjustments on to the mobile cluster and receive a selection of one or more of the recommended adjustments from the one or more user devices to facilitate addressal of the anomaly in the IOT device.

According to some embodiments of the disclosure, the IOT device is further configured to send the recommended adjustments to widgets of the one or more user devices in response to a determination that the one or more user devices are active in the mobile cluster.

According to some embodiments of the disclosure, the IOT device is further configured to send notifications to one or more inactive user devices to wake up for possible user activity.

According to some embodiments of the disclosure, the IOT device is further configured to identify a same anomaly and a way of addressing the same anomaly and send a notification regarding the way of addressing the same anomaly to the one or more user devices when the same anomaly is produced.

### BRIEF DESCRIPTION OF THE DRAWINGS

Further advantages of the invention will become apparent by reference to the detailed description of preferred embodiments when considered in conjunction with the drawings:

FIG. 1 illustrates an exemplary IOT network of connected IOT devices that are a part of a mobile cluster.

FIG. 2 illustrates another exemplary IOT network of connected IOT devices including one or more active user devices that are a part of a mobile cluster, according to an embodiment.

FIG. 3 is an exemplary flowchart illustrating the method steps involved in addressing anomalies and/or solving problems related to an IOT device, according to an embodiment.

FIG. 4 is another exemplary flowchart illustrating the steps involved in addressing anomalies and/or solving problems related to an IOT device, according to an embodiment.

FIG. 5 illustrates a set of widget examples on a user device, according to an embodiment.

FIG. 6 illustrates another set of widget examples on a user device, according to an embodiment.

FIG. 7 illustrates another set of widget examples on a user device, according to an embodiment, where the widgets indicate different issues at a premises of IOT devices.

FIG. 8 illustrates another set of widget examples on a user device, according to an embodiment, when a user of the user device leaves a premises of IOT devices.

FIGS. 9A and 9B illustrate display screens of a user device when an anomaly and/or a problem along with recommended adjustments in functioning of an anomalous and/or problematic IOT device, are reported to the user device.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

Certain terms and phrases have been used throughout the disclosure and will have the following meanings in the context of the ongoing disclosure.

A “network” may refer to a series of nodes or network elements that are interconnected via communication paths. In an example, the network may include any number of software and/or hardware elements coupled to each other to establish the communication paths and route data/traffic via the established communication paths. In accordance with the embodiments of the present disclosure, the network may include, but are not limited to, the Internet, a local area network (LAN), a wide area network (WAN), an Internet of things (IOT) network, and/or a wireless network. Further, in accordance with the embodiments of the present disclosure, the network may comprise, but is not limited to, copper transmission cables, optical transmission fibers, wireless transmission, routers, firewalls, switches, gateway computers, and/or edge servers.

A “device” may refer to an apparatus using electrical, mechanical, thermal, etc., power and having several parts, each with a definite function and together performing a particular task. In accordance with the embodiments of the present disclosure, a device may include, but is not limited to, one or more IOT devices. Further, one or more IOT devices may be related, but are not limited to, connected appliances, smart home security systems, autonomous farming equipment, wearable health monitors, smart factory equipment, wireless inventory trackers, ultra-high speed wireless internet, biometric cybersecurity scanners, and shipping container and logistics tracking.

“On-premises” may refer to the software and technology located within the physical confines of a network. An on-premises device may include, but is not limited to, a device located within the physical confines of a network. In accordance with the embodiments of the present disclosure, the term “on-premises” may be used interchangeably with the terms “site,” “office,” or “floor.”

The term “device” in some embodiments, may be referred to as equipment or machine without departing from the scope of the ongoing description.

A “processor” may include a module that performs the methods described in accordance with the embodiments of the present disclosure. The module of the processor may be programmed into the integrated circuits of the processor, or loaded in memory, storage device, or network, or combinations thereof.

An “anomaly” may refer to one or more rare items, events, or observations which raise suspicions by differing significantly from the baseline of the data associated with a device.

“Machine learning” may refer to as study of computer algorithms that may improve automatically through experience and by the use of data. Machine learning algorithms build a model based at least on sample data, known as “training data,” in order to make predictions or decisions without being explicitly programmed to do so. Machine learning algorithms are used in a wide variety of applications, such as in medicine, email filtering, speech recognition, and computer vision, where it is difficult or unfeasible to develop conventional algorithms to perform the needed tasks.

In machine learning, a common task is the study and construction of algorithms that can learn from and make predictions on data. Such algorithms function by making data-driven predictions or decisions, through building a mathematical model from input data. These input data used to build the model are usually divided in multiple data sets. In particular, three data sets are commonly used in various stages of the creation of the model: training, validation, and test sets.

The model is initially fit on a “training data set,” which is a set of examples used to fit the parameters of the model. The model is trained on the training data set using a supervised learning method. The model is run with the training data set and produces a result, which is then compared with a target, for each input vector in the training data set. Based at least on the result of the comparison and the specific learning algorithm being used, the parameters of the model are adjusted. The model fitting can include both variable selection and parameter estimation.

Successively, the fitted model is used to predict the responses for the observations in a second data set called the “validation data set.” The validation data set provides an unbiased evaluation of a model fit on the training data set while tuning the model's hyperparameters. Finally, the “test data set” is a data set used to provide an unbiased evaluation of a final model fit on the training data set.

“Deep learning” may refer to a family of machine learning models composed of multiple layers of neural networks, having high expressive power and providing state-of-the-art accuracy.

“Database” may refer to an organized collection of structured information, or data, typically stored electronically in a computer system.

“Command and Control Center” may refer to a management unit connected to every IOT device. Command and Control Centers are responsible, but are not limited for, software maintenance, configurations, firmware updates to patch bugs and vulnerabilities, as well as provisioning and authentication of tasks, such as device enrollment, for the connected devices. A Command and Control Center may include, but is not limited to, a console through which problems related to IOT devices are solved and/or decisions related to the IOT devices are made.

“Application Programming Interface (API)” may be used to enable communication between various devices in a network. Once a device's manufacturer exposes its API, other devices or applications may use it to gather data and for communication. Some APIs allow control over devices.

“Mobile clustering” may refer to grouping of devices to perform a particular operation. The mobile clustering helps not only in collaboration between different devices but also in prolonging overall network lifetime.

“Widgets” may refer to “software widgets” which in turn may be added to a user (mobile) device's home as a quick way to access certain information from user (mobile) device applications without having to open the applications themselves. An example of a widget is the “Calendar” widget, which provides a quick view of the upcoming events in a calendar without having to open the “Calendar” application.

“Kubernetes cluster” may refer to a set of nodes that run containerized applications.

“Sprites” may refer to a two-dimensional bitmap that is integrated into a larger scene, in computer graphics.

The present disclosure aims to provide quick human interaction (through user devices) to an anomaly and/or a problem reported by an IOT device without forcing any human resource to be present at a console (used for addressing anomalies and/or solving problems) associated with the IOT device. In particular, the present disclosure facilitates performing workflow related tasks of an IOT device when said IOT device reports an anomaly. Quick human interaction is provided by adding devices associated with different users into a mobile cluster of IOT devices. This step can be thought of as a “workflow” related to one or more IOT devices but with human acceptance of the model anomaly choices.

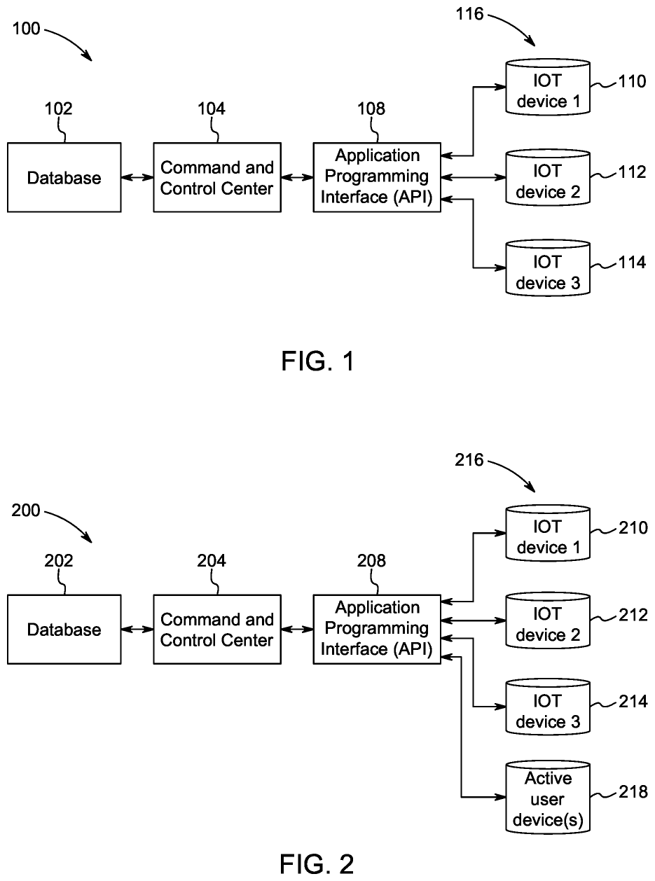

The embodiments of methods, apparatuses, and systems are described in more detail with reference to FIGS. 1-9.

FIG. 1 illustrates an exemplary IOT network 100 of connected IOT devices (110, 112, 114) that are a part of a mobile cluster 116. Each connected IOT device (110, 112, 114) may have a unique identifier, where the connected IOT device (110, 112, 114) automatically collects and exchanges data over the IOT network 100. IOT devices are used in multiple sectors and industries, including but not limited to: connected appliances, smart home security systems, autonomous farming equipment, wearable health monitors, smart factory equipment, wireless inventory trackers, ultra-high speed wireless internet, biometric cybersecurity scanners, and shipping container and logistics tracking. Further, the number of IOT devices worldwide now numbers in billions. In an embodiment, the mobile cluster 116 may be a Kubernetes cluster.

In an embodiment, to function as intended, IOT devices (110, 112, 114) need to be managed both internally, (e.g., software maintenance) and externally (i.e., their communication with other IOT devices and entities). In an embodiment, this is accomplished by connecting every IOT device (110, 112, 114) to a management unit, known as a Command and Control Center 104. Command and Control Centers are responsible for software maintenance, configurations, firmware updates to patch bugs and vulnerabilities, as well as the provisioning and authentication of tasks, such as IOT device enrollment. In an embodiment, the Command and Control center 104 may include, but is not limited to, a console through which problems related to the IOT devices (110, 112, 114) are solved and/or decisions related to the IOT devices (110, 112, 114) are made.

Communication between the IOT devices (110, 112, 114) may be enabled via Application Program Interface (API) 108. Once an IOT device's manufacturer exposes its API, other IOT devices or applications may use it to gather data and to communicate. Some APIs allow control over IOT devices. In accordance with the embodiments of the present disclosure, one or more methods discussed throughout the disclosure may be implemented at the API 108 or at any other entity within the IOT network, and one or more apparatuses and one or more systems discussed throughout the disclosure may be realized at the API 108 or any other entity.

The database 102 may store data collected in many places in the IOT network 100. In an embodiment, the data may be collected on IOT devices (110, 112, 114). In an embodiment, the data may be collected on one or more of API 108 and Command and Control center 104.

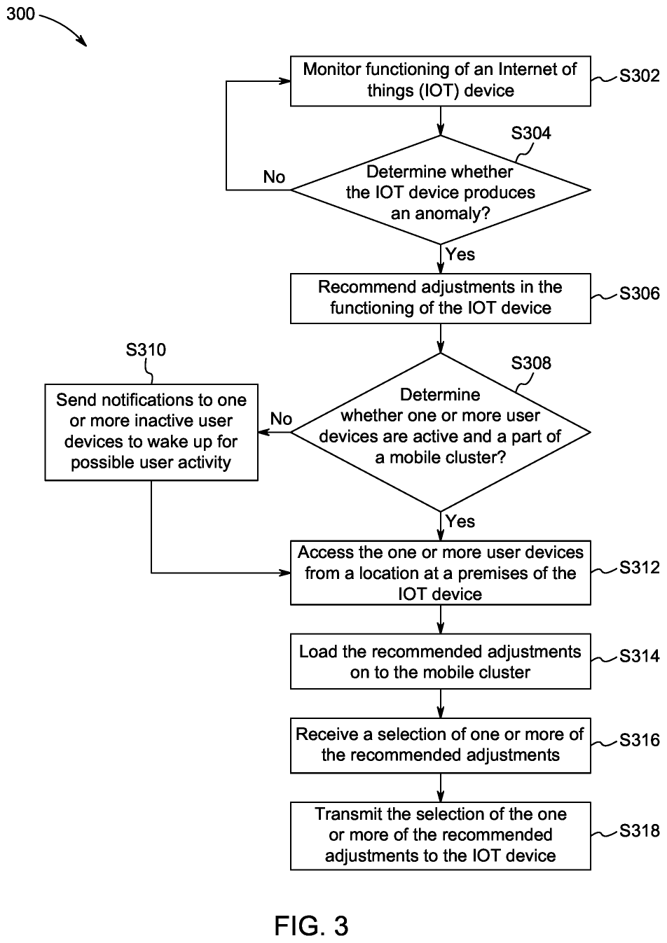

FIG. 2 illustrates an exemplary IOT network 200 of connected IOT devices (210, 212, 214) including one or more active user device 218 that are a part of a mobile cluster 216, according to an embodiment. In accordance with the embodiments of the present disclosure, a process of adding human interaction into a mobile cluster by adding active user devices into the mobile cluster is discussed in conjunction with FIG. 1. Further, in accordance with the embodiments of the present disclosure, one or more methods discussed throughout the disclosure may be implemented at the API 208 or at any other entity within the IOT network 200, and one or more apparatuses and one or more systems discussed throughout the disclosure may be realized at the API 208 or at any other entity within the IOT network 200, where the one or more methods and/or the one or more apparatuses and/or the one or more systems may address anomalies in an IOT device (201, 212, 214) without a user being assigned to a console of the IOT device (210, 212, 214).

With respect to FIG. 2, when one or more of a first machine learning model, a first deep learning model, or a combination thereof, implemented in the IOT network 200 and assigned to monitor an IOT device (210, 212, 214), determine an anomaly and/or reports a problem with respect to functioning of the IOT device (210, 212, 214), and when one or more of a second machine learning model, a second deep learning model, or a combination thereof, produce some recommended adjustments to the functioning of the IOT device (210, 212, 214) in order to address the anomaly and/or solve the problem, the recommended adjustments may be pushed onto the mobile cluster 216, by an apparatus and/or a system in accordance with the embodiments of the present disclosure. While accessing one or more devices of users from any location at a premises of the IOT device (210, 212, 214), the apparatus and/or the system determine the one or more user devices to be active and to be a part of the mobile cluster 216. In an embodiment, the user devices are mobile devices associated with the user. The recommended adjustments are sent to widgets of the one or more user devices 218 that are determined to be active and a part of the mobile cluster 216. One or more users may use the one or more user devices 218 that are a part of the mobile cluster 216, to pick one or more recommended adjustments, and the one or more recommended adjustments may be sent, by the one or more user devices 218 directly or through the apparatus and/or the system, to any of the IOT devices (210, 212, 214), thus facilitating the addressal of the anomaly and/or finding the solution to the problem with respect to the functioning of the IOT device (210, 212, 214). One or more user devices are determined to be active and a part of the mobile cluster 216 at least when the one or more user devices are positioned in a network zone and/or an indoor mapping location at the premises of the IOT device (210, 212, 214).

Further, if no user devices are determined to be active, notifications may be sent to one or more inactive user devices to wake up for possible user activity. One or more inactive user devices become active in response to the notifications. In an embodiment, the notifications comprise remote notifications that may be sent to one or more inactive user devices to wake up for possible user activity. Further, when one or more inactive user devices wake up, they join the mobile cluster 216 as active again. Further, in an embodiment, the notifications enable one or more inactive user devices that are outside a network zone and/or an indoor mapping location at a premises of the IOT device (210, 212, 214), to login to the apparatus and/or the system remotely, and become active. In summary, the notifications prevent the anomaly and/or the problem with respect to the functioning of the IOT device (210, 212, 214) from being ignored if no user device is available at the premises of the IOT device (210, 212, 214).

In accordance with an alternative or additional embodiment of the present disclosure, the one or more user devices are determined to be active and a part of the mobile cluster 216 at least when the one or more user devices have a mobile application installed and configured on the one or more user devices. Further, in an embodiment, the mobile application is registered with the apparatus and/or the system. Furthermore, in an embodiment, the mobile application may be an EdgeOps mobile application installed and configured on the one or more user devices.

In accordance with an embodiment of the present disclosure, different active user devices 218 are added into the mobile cluster 216 for one or more of different machine learning models, different deep learning models, or combinations thereof.

In accordance with an embodiment of the present disclosure, a same anomaly produced over multiple number of times and a way of addressing the same anomaly for multiple number of times is identified. Further, a notification regarding the way of addressing the same anomaly is sent to the one or more active user devices when the same anomaly is produced.

In accordance with an embodiment of the present disclosure, ways of addressing previous anomalies are provided as inputs to one or more of a third machine learning model, a third deep learning model, or a combination thereof, such that future anomalies are addressed based at least on the ways of addressing previous anomalies.

In accordance with an embodiment of the present disclosure, the adjustments in the functioning of the IOT device (210, 212, 214) are recommended by one or more of the second machine learning model, the second deep learning model, or a combination thereof, in an order that will most likely address the anomaly in the IOT device (210, 212, 214). In an embodiment, the adjustments may be customized to the IOT device (210, 212, 214).

In accordance with an embodiment of the present disclosure, picking up of one or more recommended adjustments is based at least on availability of the one or more active user devices 218. In an embodiment, a Kubernetes cluster may be used to determine the availability of the one or more user devices 218.

In accordance with an embodiment of the present disclosure, the recommended adjustments are sent to the widgets of the one or more active user devices 218 of the mobile cluster 216 by sending sprites to represent the anomaly and 3-D animations to indicate what adjustments are being recommended by one or more of the second machine learning model, second deep learning model, or a combination thereof, to the functioning of the IOT device (210, 212, 214).

In accordance with an embodiment of the present disclosure, the widgets may be positioned at any position on displays of respective one or more active user devices 218, and wherein the widgets are always active.

In accordance with an embodiment of the present disclosure, when the one or more active user devices 218 leave the network zone and/or the indoor mapping location at the premises of the IOT device (210, 212, 214), the widgets may become inactive.

In accordance with an embodiment of the present disclosure, the one or more user devices 218 are automatically made active and added to the mobile cluster 216 in order to address the anomalies in the IOT device (210, 212, 214).

The database 202 may store data collected in many places in the IOT network 200. In an embodiment, the data may be collected on IOT devices (210, 212, 214) or on the one or more active user devices 218. In an embodiment, the data may be collected on one or more of API 208 and Command and Control center 204.

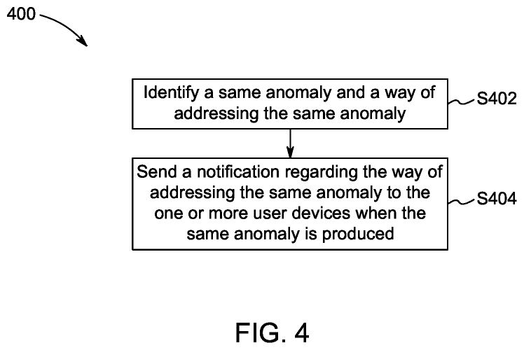

FIG. 3 is an exemplary flowchart illustrating the method steps involved in addressing anomalies and/or solving problems related to an IOT device (210, 212, 214), according to an embodiment. FIG. 3 discusses the various operations performed by an apparatus and/or a system for providing an on-premises solution to address anomalies and/or solve a problem related to the IOT device (210, 212, 214) without a user being assigned to a console of the IOT device (210, 212, 214). In an embodiment, the IOT device (210, 212, 214) is a part of a mobile cluster 216. In an embodiment, the mobile cluster 216 is a Kubernetes cluster.

Referring to FIG. 3, in step S302, the apparatus and/or the system monitor functioning of the IOT device (210, 212, 214). In an embodiment, the functioning of the IOT device (210, 212, 214) may be monitored to determine whether the IOT device (210, 212, 214) produces an anomaly and/or reports a problem at a premises of the IOT device (210, 212, 214). In an embodiment, the determination is based on one or more of a first machine learning model, a first deep learning model, or a combination thereof.

Further, in step S304, the apparatus and/or the system may determine whether the IOT device (210, 212, 214) produces an anomaly. If yes, the flow of the operations proceeds on to step S306. Else, the apparatus and/or the system continue monitoring functioning of the IOT device (210, 212, 214).

Furthermore, in step S306, the apparatus and/or the system recommend adjustments in the functioning of the IOT device (210, 212, 214) based on one or more of second machine learning model, a second deep learning model, or a combination thereof. In an embodiment, the adjustments in the functioning of the IOT device (210, 212, 214) are recommended by one or more of the second machine learning model, the second deep learning model, or a combination thereof, in an order that will most likely address the anomaly and/or solve the problem in the IOT device (210, 212, 214).

Additionally, in step S308, the apparatus and/or the system determine whether one or more user devices 218 are active and a part of a mobile cluster 216. If yes, the flow of the operations proceeds on to step S312. Else, the flow of the operations proceeds on to step S310. In an embodiment, the one or more user devices 218 are determined to be active and a part of the mobile cluster 216 at least when the one or more user devices 218 are positioned in a network zone and/or an indoor mapping location at the premises of the IOT device (210, 212, 214). Additionally, or alternatively, the one or more user devices 218 are determined to be active and a part of the mobile cluster 216 at least when the one or more user devices 218 have a mobile application installed and configured on the one or more user devices 218. In an embodiment, the mobile application is registered with the apparatus and/or the system. Further, in an embodiment, the mobile application may be an EdgeOps mobile application installed and configured on the one or more active user devices 218.

Additionally, in step S310, the apparatus and/or the system may send notifications to one or more inactive user devices to wake up for possible user activity. The one or more inactive user devices correspond to user devices other than the active user devices 218. Further, in an embodiment, the one or more inactive user devices become active in response to the notifications to wake up for possible user activity. Furthermore, in an embodiment, the notifications to the one or more inactive user devices to wake up for possible user activity are sent by sending remote notification to the one or more inactive user devices. Additionally, in an embodiment, the notifications to the one or more inactive user devices to wake up for possible user activity are sent by sending remote notifications to the one or more inactive user devices such that when the one or more inactive user devices are outside the network zone and/or the indoor mapping location at a premises of the IOT device (210, 212, 214), the one or more inactive user devices are configured to login to the apparatus and/or the system remotely based at least on the remote notifications, and become active.

Additionally, in step S312, the apparatus and/or the system access the one or more user devices 218 from a location at a premises of the IOT device (210, 212, 214).

Additionally, in step S314, the apparatus and/or the system load the recommended adjustments on to the mobile cluster 216. In particular, the apparatus and/or the system load the recommended adjustments on to the mobile cluster 216 by sending the recommended adjustments to widgets of one or more user devices 218 that are determined to be active and a part of the mobile cluster 216. In an embodiment, the widgets can be positioned at any position on displays of respective one or more active user devices 218, and the widgets are always active. In an embodiment, the apparatus and/or the system send the recommended adjustments to the widgets of the one or more active user devices 218 of the mobile cluster 216 by sending sprites to represent the anomaly and 3-D animations to indicate what adjustments are being recommended by one or more of the second machine learning model, second deep learning model, or a combination thereof, to the functioning of the IOT device (210, 212, 214).

Additionally, in step S316, the apparatus and/or the system receives a selection of one or more of the recommended adjustments. In an embodiment, receiving the selection of the one or more of the recommended adjustments from the one or more active user devices 218 is based at least on availability of the one or more active user devices 218.

Additionally, in step S318, the apparatus and/or the system transmit the selection of the one or more of the recommended adjustments to the IOT device (210, 212, 214). The transmission of the selection of the one or more of the recommended adjustments to the IOT device (210, 212, 214) facilitates addressing the anomaly in the IOT device (210, 212, 214), and performing workflow related tasks of the IOT device (210, 212, 214).

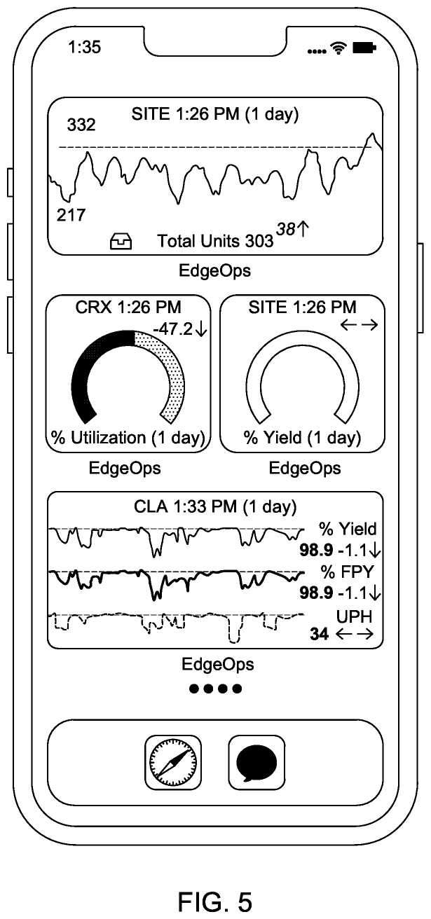

FIG. 4 is another exemplary flowchart illustrating the steps involved in addressing anomalies and/or solving problems related to an IOT device (210, 212, 214), according to an embodiment. FIG. 4 discusses operations performed by an apparatus and/or a system for providing an on-premises solution to address anomalies and/or solve problems related to the IOT device (210, 212, 214) without a user being assigned to a console of the IOT device (210, 212, 214). In an embodiment, the IOT device (210, 212, 214) is a part of a mobile cluster 216. In an embodiment, the mobile cluster 216 is a Kubernetes cluster.

In step S402, the apparatus and/or the system identify a same anomaly produced and a way of addressing the same anomaly.

In step S404, the apparatus and/or the system send a notification regarding the way of addressing the same anomaly to the one or more active user devices 218 when the same anomaly is produced.

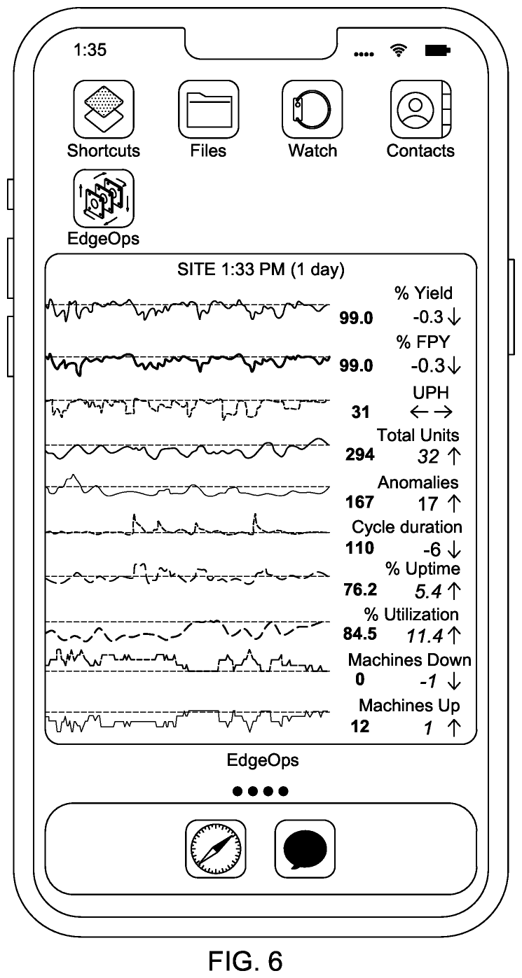

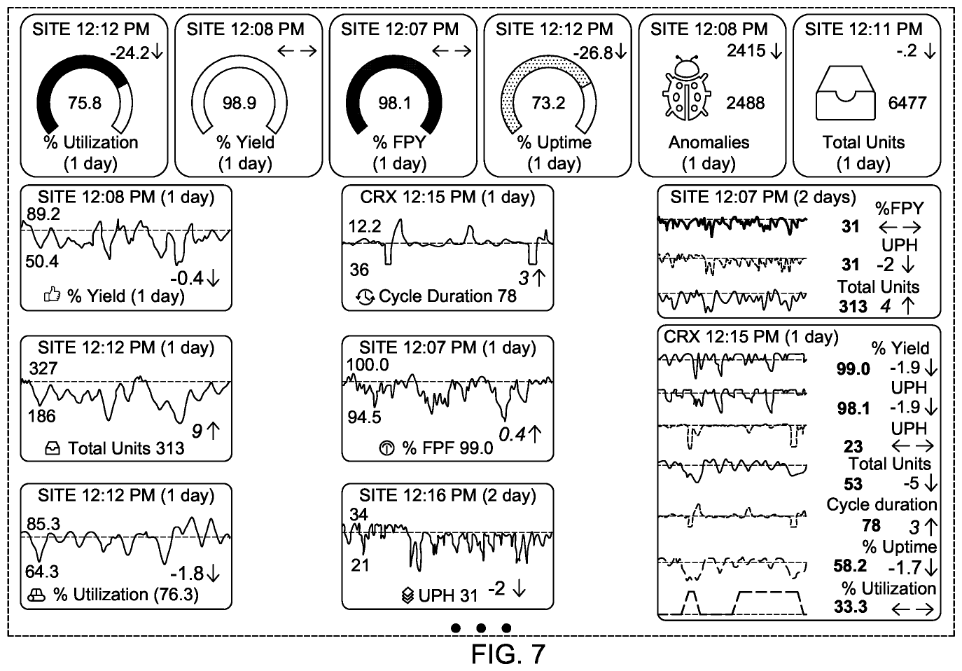

FIGS. 5 and 6 illustrate sets of widget examples on a user device 218, according to embodiments. The sets of widget examples correspond to data coming in on the user device 218 regardless of a mobile application (used in addressing anomalies in IOT devices) on the user device 218 being used or active. In particular, FIGS. 5 and 6 illustrate some widget examples of the data coming in on the user device 218 from one or more IOT devices (210, 212, 214) in the IOT environment 200. The data is related, but is not limited to, one or more parameters related to the IOT environment 200. In an embodiment, the one or more parameters include, but are not limited to, percentage Yield (% Yield), Units Per Hour (UPH), percentage First pass yield (% FPY), percentage Utilization (% Utilization), and percentage Uptime (% Uptime).

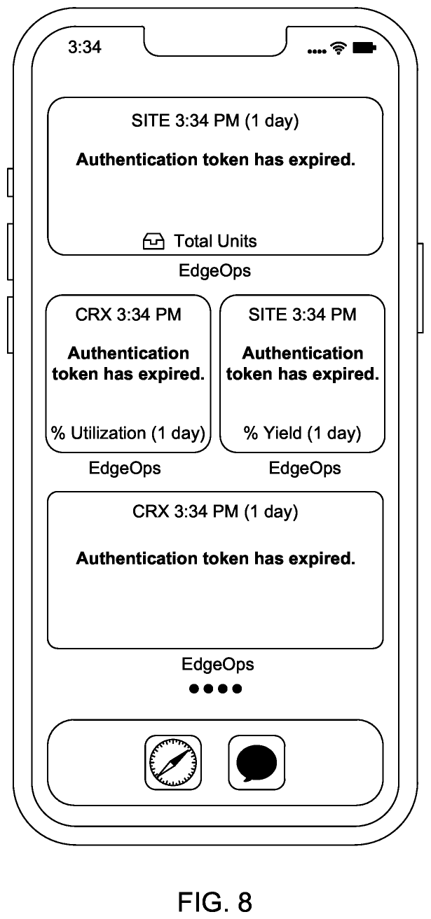

FIG. 7 illustrates another set of widget examples on a user device 218, according to an embodiment. The widget examples correspond to data coming in on the user device 218 regardless of a mobile application (used in addressing anomalies in IOT devices) on the user device 218 being used or active. When compared to FIGS. 5 and 6, the widgets of FIG. 7 indicate different issues present at a premises of the IOT devices (210, 212, 214).

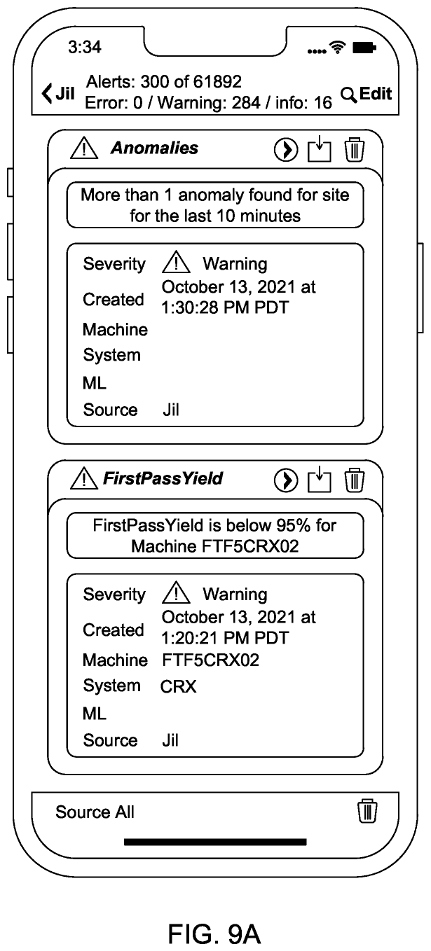

FIG. 8 illustrates another set of widget examples on a user device 218, according to an embodiment, when a user of the user device 218 leaves a premises of the IOT device (210, 212, 214). When the user leaves the network zone and/or the indoor mapping location at the premises of the IOT device (210, 212, 214), the widgets become inactive. In an embodiment, this may be shown by displaying a message indicating that an authentication has expired. However, in another embodiment, this may be shown by indicating that the user device 218 is in an offline state.

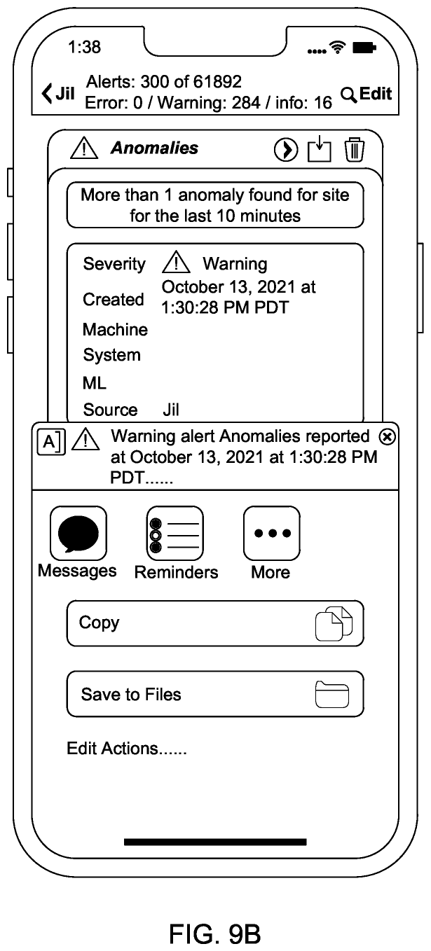

FIGS. 9A and 9B illustrate display screens of a user device 218 when an anomaly and/or a problem along with recommended adjustments in functioning of an anomalous and/or problematic IOT device (210, 212, 214), are reported to the user device 218. When an event indicating an anomaly and/or a problem with respect to an IOT device (210, 212, 214) comes in, a user may respond through an active user device 218. When the user clicks on a display screen of the active user device 218, to know more about the anomaly and/or the problem, there would be a list of possible recommended adjustments displayed on the screen. In a non-limiting example and as shown in FIGS. 9A and 9B, the display screen of the user device 218 shows just the “copy” and “Save to Files” options and no other options depicting the list of possible recommended adjustments is displayed.

In view of the above description, the embodiments presented herein enable the addressal of anomalies and/or finding a solution to a problem related to an IOT device without a user being assigned to a console of the IOT device. Further, the embodiments presented herein facilitate an IOT device to perform workflow related tasks when the IOT device reports an anomaly and/or a problem. Furthermore, the embodiments presented herein facilitate working with user devices that are active in a premises of IOT devices which has the advantage of mobile applications working on tasks instead of waiting for a notification to be pushed and a user waking up the mobile application. Additionally, the embodiments presented herein provide an on-premises type solution verses a cloud-based product, where a user is allowed to leave the traditional workstation dashboard monitoring. Additionally, the embodiments presented herein do not require the mobile application to be actively running on the user device 218, to support a problem area of an IOT devices. Using device widgets, the response needed may be provided allowing other activities on the user device.

In an embodiment, one or more apparatuses may be utilized in implementing embodiments consistent with the present disclosure. In an example, the one or more apparatuses comprise a memory and a processor coupled to the memory. In an example, the processor is configured to perform steps or stages consistent with the embodiments described herein.

In an embodiment, one or more systems may be utilized in implementing embodiments consistent with the present disclosure. In an example, the one or more systems may include one or more entities corresponding to an exemplary IOT network 100 discussed in FIG. 1, or an exemplary IOT network 200 discussed in FIG. 2, the one or more entities being configured to perform steps or stages consistent with the embodiments described herein.

In an embodiment, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

The terms “comprising,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the networks, devices, and/or modules described herein contain optional features that can be individually or together applied to any other embodiment shown or contemplated here to be mixed and matched with the features of such networks, devices, and/or modules.

While the invention has been described with respect to a limited number of embodiments, those skilled in the art, having benefit of this disclosure, will appreciate that other embodiments can be devised which do not depart from the scope of the invention as disclosed herein.

I/We claim:

1. An apparatus for addressing anomalies in an Internet of things (IOT) device, the IOT device being a part of a mobile cluster, the apparatus comprising:
a memory; and
a processor coupled to the memory and configured to:
determine whether the IOT device produces an anomaly based at least on a first machine learning model;
determine adjustments to recommend in functioning of the IOT device based at least on a second machine learning model in response to a determination that the IOT device produces the anomaly;
send the recommended adjustments to one or more user devices that are a part of the mobile cluster to load the recommended adjustments on to the mobile cluster; and
receive a selection of one or more of the recommended adjustments from the one or more user devices to facilitate addressal of the anomaly in the IOT device.

2. The apparatus according to claim 1, wherein the recommended adjustments are sent to widgets of the one or more user devices in response to a determination that the one or more user devices are active in the mobile cluster.

3. The apparatus according to claim 2, wherein the one or more user devices are determined to be active and part of the mobile cluster at least when the one or more user devices are positioned in a network zone and/or an indoor mapping location at the premises of the IOT device.

4. The apparatus according to claim 3, wherein the processor is further configured to send notifications to one or more inactive user devices to wake up for possible user activity.

5. The apparatus according to claim 4, wherein the one or more inactive user devices correspond to user devices other than the active user devices.

6. The apparatus according to claim 5, wherein the one or more inactive user devices become active in response to the notifications to wake up for the possible user activity.

7. The apparatus according to claim 1, wherein the processor is further configured to:
identify a same anomaly and a way of addressing the same anomaly; and
send a notification regarding the way of addressing the same anomaly to the one or more user devices when the same anomaly is produced.

8. The apparatus according to claim 1, wherein the mobile cluster is at least a Kubernetes cluster.

9. A method for addressing anomalies in an Internet of things (IOT) device, the IOT device being a part of a mobile cluster, the method comprising:
determining whether the IOT device produces an anomaly based at least on a first machine learning model;
determining adjustments for recommending in functioning of the IOT device based at least on a second machine learning model in response to a determination that the IOT device produces the anomaly;
sending the recommended adjustments to one or more user devices that are a part of the mobile cluster for loading the recommended adjustments on to the mobile cluster; and
receiving a selection of one or more of the recommended adjustments from the one or more user devices for facilitating addressal of the anomaly in the IOT device.

10. The method according to claim 9, further comprising:
sending the recommended adjustments to widgets of the one or more user devices in response to a determination that the one or more user devices are active in the mobile cluster.

11. The method according to claim 10, wherein the one or more user devices are determined to be active and part of the mobile cluster at least when the one or more user devices are positioned in a network zone and/or an indoor mapping location at the premises of the IOT device.

12. The method according to claim 11, further comprising:
sending notifications to one or more inactive user devices to wake up for possible user activity.

13. The method according to claim 12, wherein the one or more inactive user devices correspond to user devices other than the active user devices.

14. The method according to claim 13, wherein the one or more inactive user devices become active in response to the notifications to wake up for the possible user activity.

15. The method according to claim 9, further comprising:
identifying a same anomaly and a way of addressing the same anomaly; and
sending a notification regarding the way of addressing the same anomaly to the one or more user devices when the same anomaly is produced.

16. The method according to claim 9, wherein the mobile cluster is at least a Kubernetes cluster.

17. A system for addressing anomalies in a mobile cluster, the system comprising:
one or more user devices that are a part of the mobile cluster; and
an Internet of things (IOT) device, the IOT device being a part of a mobile cluster, the IOT being configured to:
determine whether the IOT device produces an anomaly based at least on a first machine learning model;
determine adjustments to recommend in functioning of the IOT device based at least on a second machine learning model in response to a determination that the IOT device produces the anomaly;
send the recommended adjustments to one or more user devices that are a part of the mobile cluster to load the recommended adjustments on to the mobile cluster; and
receive a selection of one or more of the recommended adjustments from the one or more user devices to facilitate addressal of the anomaly in the IOT device.

18. The system according to claim 17, wherein the IOT device is further configured to:
send the recommended adjustments to widgets of the one or more user devices in response to a determination that the one or more user devices are active in the mobile cluster.

19. The system according to claim 17, wherein the IOT device is further configured to:
send notifications to one or more inactive user devices to wake up for possible user activity.

20. The system according to claim 17, wherein the IOT device is further configured to:
identify a same anomaly and a way of addressing the same anomaly; and
send a notification regarding the way of addressing the same anomaly to the one or more user devices when the same anomaly is produced.
